(19) United States
(12) Patent Application Publication
(10) Pub. No.: US 2014/0060694 A1
(43) Pub. Date: Mar. 6, 2014

(54) Air Transfer Device

(71) Applicant: Richard Heydenberk, Cadillac, MI (US)

(72) Inventor: Richard Heydenberk, Cadillac, MI (US)

(21) Appl. No.: 14/013,368

(22) Filed: Aug. 29, 2013

Related U.S. Application Data
(60) Provisional application No. 61/696,410, filed on Sep. 4, 2012.

(51) Int. Cl. B60S 5/04

(52) U.S. Cl. CPC B60S 5/04
USPC 141/4; 141/230; 141/95

(57) ABSTRACT

What is provided is a portable air hose device for transferring air between tires of a vehicle. It has a locking end for attaching to a tire into which air is to be added, a coiled hose, and an end for attaching to the valve of another tire, from which air is to be transferred away. The attaching end may be locking or non-locking. The hose may be a coiled hose or in some examples it may be a straight air hose. The volume of air transferred may be regulated by the user, and some examples may have a pressure gauge to measure air flow transfer. A user may attach the device between two tires to transfer air tire to tire. The device may be used to add air to flat tires and/or low tires, and/or to equalize air pressure in the tires of a vehicle.

### CLAIM OF PRIORITY

This application claims priority to and the benefit of the filing date of provisional application, U.S. Ser. No. 61/696,410, filed on Sep. 4, 2012.

### FIELD

This disclosure relates to a device for transferring air between tires of a vehicle.

### BACKGROUND

Air pumps, such as portable bicycle pumps and generator or air compressor powered air pump stations, such as those that may be commonly found at service stations, are known devices for pumping air into the tires of a vehicle. Portable bicycle pumps often consist of a manual pump having a hose connected thereto, with a valve end that may be attached to a tire valve to pump air into a tire. A user may pump air into a tire manually by pumping the air pump. Compressor or generator powered pumps may pump air mechanically. Some such portable air pumps have pressure gauges for measuring air pressure within the tire.

Similarly, air station pumps often include a valve located on a distal end of an air hose that is attached to an air pump, which may commonly be powered by an air compressor. A user may pump air into a tire by powering on the air pump and compressor and connecting the valve end to the tire valve.

However, sometimes a low pressure or flat tire occurs in remote locations, where a driver is not near a service station. In such instances it may be difficult or not possible to drive a vehicle to a service station for pumping air into a tire having low pressure or that has become flat without causing damage to the tire.

For low pressure or flat vehicle tire situations, the tire may be large, and using a portable bicycle tire pump may not be effective for automobile, truck, trailer or other motorized vehicle tires due to their larger size and/or tire pressure. Hand pumping air into such a tire may be thwarted and/or prohibited due to the difficulty and/or level of physical exertion required to accomplish such as task. As such, a vehicle operator with a flat tire that he is able to repair, and/or a low pressure tire, may not have air to pump into the offending tire at the remote location.

Accordingly, there is a need for a portable device for adding air to a tire, such as a low pressure tire or flat tire, that may be employed for tires of a motorized vehicle, such as an automobile, truck, motorhome, trailer, and the like. There is a need for a portable device for adding air to a tire of a vehicle that does not require a high level of physical exertion to operate. There is a need for a device that may be used to add air to a tire in locations away from service stations. There is a need for a portable air pump device that may inflate vehicle tires without requiring AC or DC power, having numerous complex parts or requiring use of a generator or air compressor.

Finally, there is lack of a device which may be used to transfer air from tire to tire to equalize tire pressure.

### SUMMARY

What is provided is a portable air hose device for transferring air between tires of a vehicle, but not limited to, a car, trailer, truck, motorhome, semi-truck, tractor, bike, tri-wheeled bicycle, ATV, air plane, space shuttle or other vehicle or transportation device and the like. It has a locking end for attaching to a tire into which air is to be added, a coiled hose, and an end for attaching to the valve of another tire from which air is to be transferred away. The attaching end for transferring air away from a tire may be locking or non-locking. The device may be used to add air to flat tires and/or low tires. A user may attach the device between two tires to transfer air tire to tire. The device may be of different lengths for different applications, including hoses sufficient in length to reach all tires of a vehicle for air transfer. The hose may be a coiled hose, or in some examples, it may be a straight air hose. The hose may possess pressure withstanding characteristics such that air transfer is possible between tires. The volume of air transferred may be regulated by the user, and some examples may have a pressure gauge to measure air flow transfer. The device may be used to equalize air pressure in the tires of a vehicle.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is an example of a portable air transfer device example;

FIG. 2 is an example of an attaching end of a portable air transfer device example;

FIG. 3 is an example of a second end of a portable air transfer device example; and

FIGS. 4a-4d show an example of a manner of using a portable air transfer device.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

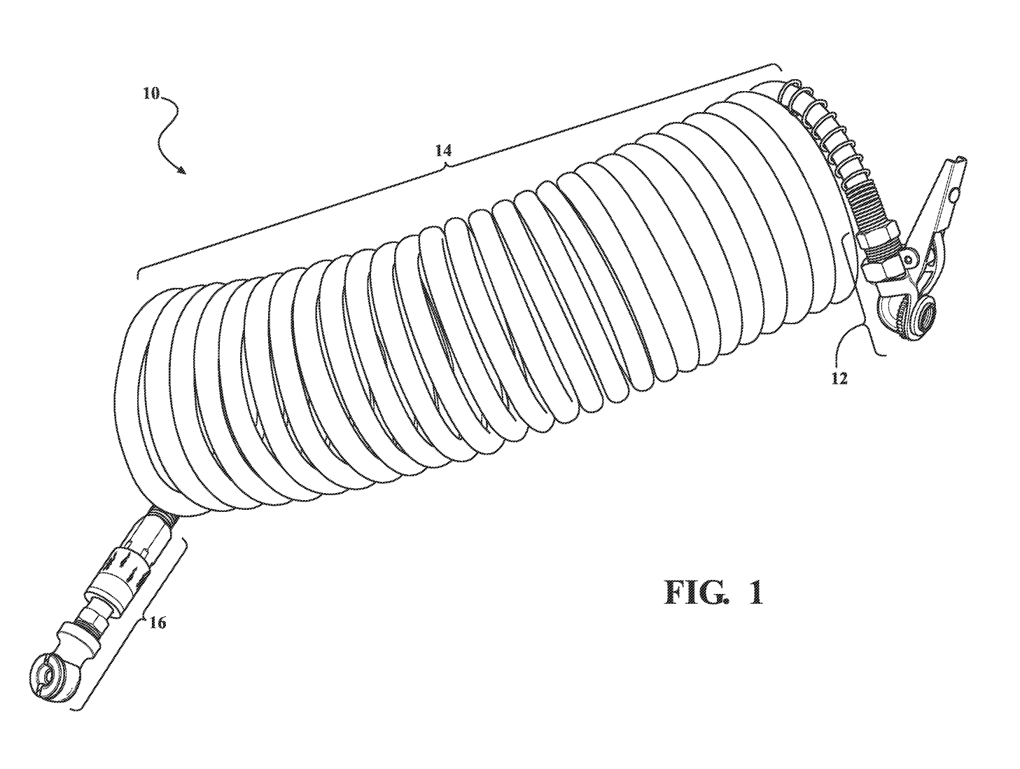

Referring to FIG. 1, an air transfer device 10 is provided. Air transfer device 10 has a locking end 12, an air hose 14, and an attaching end 16. Air hose 14 is connected between locking end 12 and attaching end 16 such that the connection is substantially air tight without allowing substantial air to leak outside of device 10. Air hose 14 is connected between ends 12 and 16 such that air may pass therethrough. Air hose 14 is connected between ends 12 and 16 such that air pressure therein may be substantially equal and/or constant in some examples.

Air hose 14 may be a coiled and/or self-coiling air hose in various examples. Coiled examples may stretch to a greater length, such as during use, but may coil to make device 10 easier to store than examples having a straight and/or non-coiling air hose 14. However, a straight and/or non-coiling air hose 14 is possible with other examples. Some examples may have a retractable air hose 14.

Air hose 14 may be of various lengths, including lengths capable of reaching between two or more or all tires of a vehicle, such as but not limited to, a bicycle, tri-wheeled vehicle, ATV, motorcycle, automobile, truck, trailer, motorhome, semi-truck, tractor, air plane, space shuttle, and other vehicles. In some examples, air hose 14 may be approximately 25 feet in length. Air hose 14 may be of a length capable of reaching between tires of different vehicles, such as but not limited to, between two cars, between a unicycle and a bicycle, between a tractor and a trailer, and the like. Claimed subject matter is not limited to use with any particular type or size of vehicle. In fact, device 10 may be used to transfer air between tires not associated with any vehicle at all.

In some examples, air hose 14 may be capable of withstanding 200 psi of air pressure. In other examples, it may be capable of withstanding different pressures, so as to be capable of being used to transfer air between tires of various sizes and psi air pressures and air pressure requirements. Claimed subject matter is not intended to be limited to a particular psi.

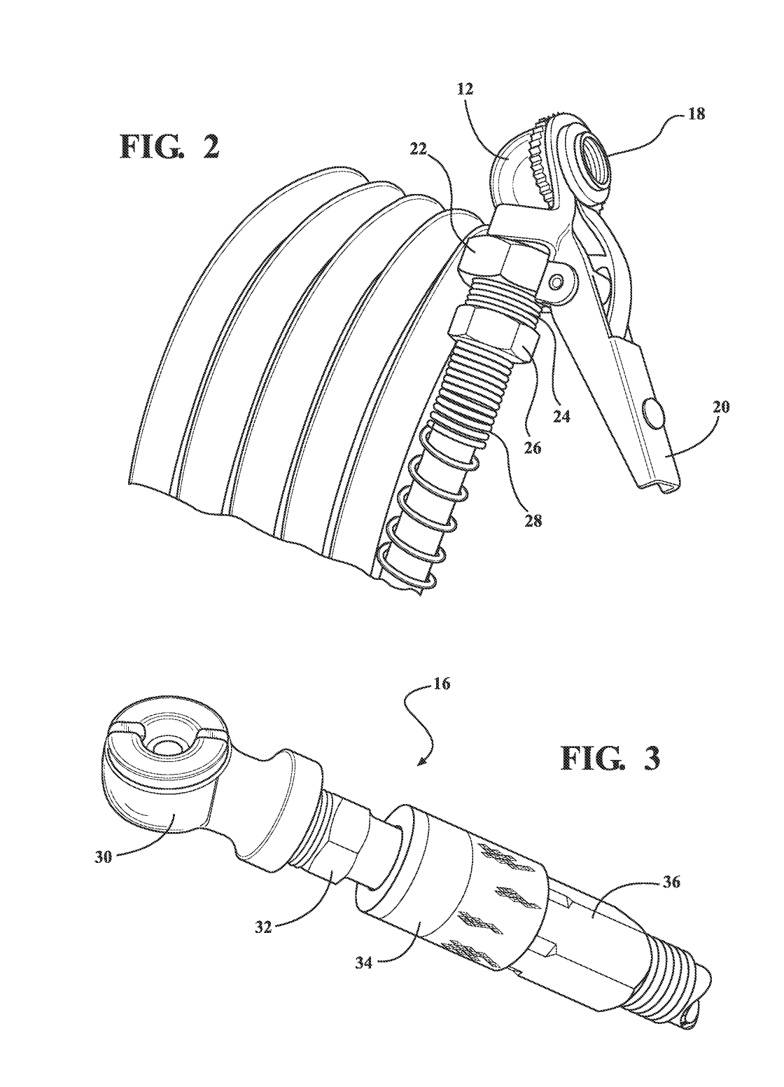

As shown in FIG. 2, locking end 12 has a locking air valve 18. Locking air valve 18 may be attached to a tire valve such that it is capable of having air pass therethrough when in a closed or locked position. In some examples locking air valve 18 has a lever 20, which may be rotated to lock locking air valve 18 onto a tire valve. In some examples, locking air valve 18 has a lever 20, which may be rotated approximately 90 degrees to move from an unlocked to a locked position. Locking air valve 18 may have other mechanisms for locking it onto an air valve of a tire. For example, locking air valve 18 may comprise a ball valve, turn angle valve, and the like. Other types of locking air valves are possible within the scope and spirit of this application, and claimed subject matter is not intended to be limited to this particular example. In some examples, locking end 12 may be an air valve that is not locking. However, employing a locking feature may facilitate use of device 10 in some circumstances, such as but not limited to, use by a single user between tires located more than an arm's length apart. Some examples may include a locking air valve 18, such as that used in some portable manual bicycle air pumps, which are commonly known in the art.

Locking air valve 18 may be attached to air hose 14 by various components, parts, manners, means and/or methods, such that air is capable of passing through air hose 14 and through locking air valve 18 in a locked position and the connect is substantially air tight such that substantial air does not leak outside of device 10 at the connection. In this particular example, locking air valve 18 is attached to air hose 14 by a threaded coupling 24, hexagon couplings 22 and 24 and spring 28. In this particular example, locking air valve 18 may be attached to hexagon coupling nut 22, which may be integral to locking valve 18 or a separate part threaded thereto. Hexagon coupling nut 22 may be threaded onto threaded coupling 24. A second hexagon coupling nut 26 may be threaded onto threaded coupling 24 at the base of air hose 14. In some examples, second hexagon coupling nut 26 may be integral to air hose 14, and in other examples it may be a separate part threaded onto air hose 14. Second hexagon coupling nut 26 may be secured to air hose 14 via spring 28. Spring 28 may act to retain air hose 14 to hexagon coupling nut 24. Claimed subject matter is not intended to be limited by this particular example as a manner of connection.

Other fasteners may be used to connect, couple, affix, seal and/or attach locking end 12 to air hose 14. For example, various nuts, bolts, screws, connectors, fittings, cap nuts, wing nuts, lock nuts, hex nuts, hex bolts, u-bolts, eye bolts, carriage bolts, lag bolts, washers, epoxies, adhesives, heat bonded adhesives, crimp rings, threaded attachments, tension pins, seals, gaskets, push to connect fittings, couplings, conversion couplings, straight couplings, female adapters, male adapters, adapters, fasteners, and the like, known in the art may be used to attach air hose 14 to locking end 12. Locking end 12 may be connected to air hose 14 directly or indirectly, using one or more parts. Claimed subject matter is not intended to be limited to a particular manner of connection.

Air hose 14 is attached to locking end 12 so as to form a substantially air tight seal, such that air is able to pass therethrough substantially without air escaping out of the attachment. Air hose 14 may be attached to locking end 12 so as to form a substantially air-tight seal, such that air pressure is able to remain substantially constant and/or substantially consistent without leaking outside of device 10 while passing through the attachment. Claimed subject matter is not intended to be limited to a particular attachment example, and many manners, means and methods of attaching air hose 14 to locking end 12 are possible within the scope and spirit of this application.

In some examples, an air pressure gauge may be included in device 10. An air pressure gauge may be attached at various positions, including but not limited to, at locking end 12, attachment end 16 and/or connection points between air hose 14 and ends 12 and/or 16.

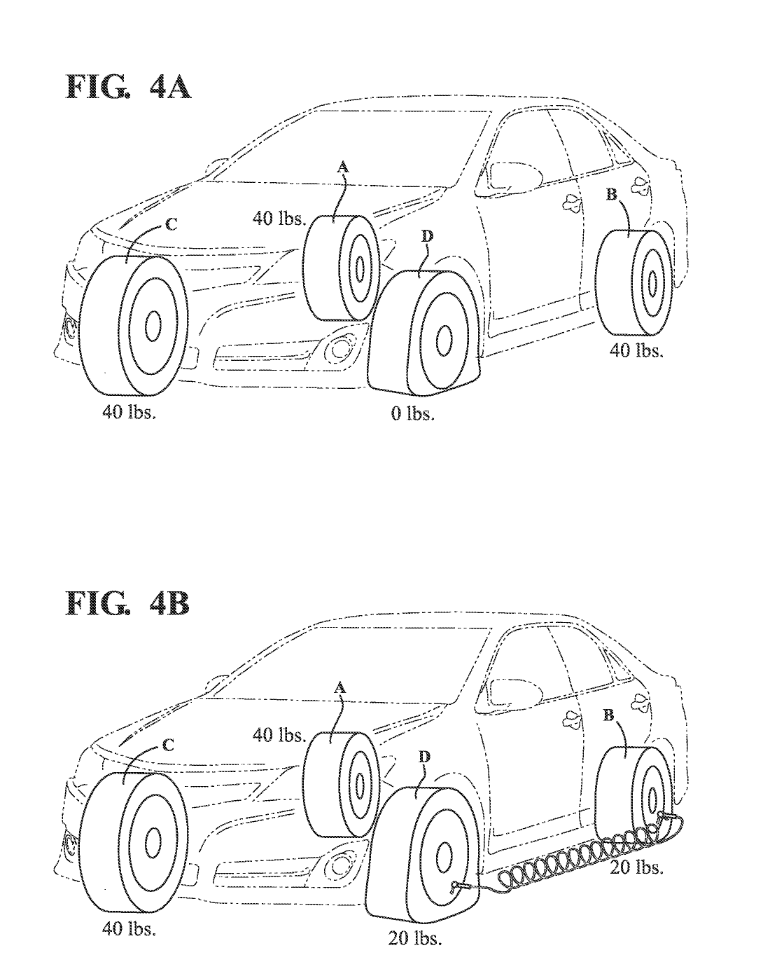

As shown in FIG. 3, attaching end 16 includes valve 30. Valve 30 may be attached to a tire valve such that it is capable of having air pass therethrough when in an engaged position pressed onto the tire valve. In some examples, valve 30 may be a locking valve. However, in other examples, valve 30 may be a standard non-locking air valve, such as that used at air pumps at service stations, which are commonly known in the art.

Valve 30 may be attached to air hose 14 by various components, parts, manners, means and/or methods, such that air is capable of passing through air hose 14 and through valve 30 in an engaged position, and the connect is substantially air tight such that substantial air does not leak outside of device 10 at the connection. In this particular example as shown in FIG. 3, attaching end 16 may be connected to air hose 14 by hexagon nuts 32 and 36 and coupling nut 34. Valve 30 may be threaded onto hex nut 32 in some examples, or hex nut 32 may be integral to valve 30 in other examples. Air hose 14 may be threaded onto hex nut 36 in some examples, or hex nut 36 may be integral to air hose 14 in other examples. Coupling nut 34 may be threaded on air hose 14, various adapters or connecters or be integral to hex nut 26 in various examples. Claimed subject matter is not intended to be limited to a particular connection assembly, and this example is one of many possible within the scope and spirit of this application.

Other fasteners may be used to connect, couple, affix, seal and/or attach attaching end 16 to air hose 14. For example, various nuts, bolts, screws, connectors, fittings, cap nuts, wing nuts, lock nuts, hex nuts, hex bolts, u-bolts, eye bolts, carriage bolts, lag bolts, washers, epoxies, adhesives, heat bonded adhesives, crimp rings, threaded attachments, tension pins, seals, gaskets, push to connect fittings, couplings, conversion couplings, straight couplings, female adapters, male adapters, adapters, fasteners, and the like known in the art may be used to attach air hose 14 to attaching end 16. Attaching end 16 may be connected to air hose 14 directly or indirectly using one or more parts. Claimed subject matter is not intended to be limited to a particular manner of connection.

Air hose 14 is attached to attaching end 16 so as to form a substantially air tight seal, such that air is able to pass therethrough substantially without air escaping out of the attachment. Air hose 14 may be attached to attaching end 16 so as to form a substantially air-tight seal, such that air pressure is able to remain substantially constant and/or substantially consistent without air leaking out of device 10 while passing through the attachment. Claimed subject matter is not intended to be limited to a particular attachment example, and many manners, means and methods of attaching air hose 14 to attaching end 16 are possible within the scope and spirit of this application.

Attaching end 16 may be locking (such as but not limited to similar to locking end 12) or it may be non-locking. In the example shown in FIG. 1, attaching end 16 is non-locking. Similarly, locking end 16 may be locking or non-locking (such as but not limited to similar to attaching end 12). In the example shown in FIG. 1, locking end 12 is locking.

Air transfer device 10 may be portable. As shown in FIG. 1, device 10 may self-coil into a substantially compact shape so as to facilitate transportation and storage. In some examples, air transfer device 10 may be capable of being stored in a vehicle which may be convenient for transportation and use. When in use, air hose 14 may stretch to separate coils and become extended in a straighter shape. Claimed subject matter is not intended to be limited to this particular coiled example.

Device 10 may be used to add air to a low pressure and/or flat tire. For example, a user may fix a flat tire and then add air to the fixed tire by using device 10 to transfer air from one or more tires of the vehicle or another vehicle. In some examples, air transfer device 10 may be kept, used or paired with a tire repair kit, such that a flat tire could first be fixed and then re-inflated. Air transfer device 10 may also be used to equalize air pressure between tires of a vehicle.

In order to use air transfer device 10, a user may connect locking end 12 to a tire valve for a tire into which air is to be added. The user may connect attaching end 16 to a tire valve for a tire from which air is to be taken. Upon connecting both the locking end 12 and attaching end 14 to two tires, air may begin to move from the tire having a higher tire air pressure through air hose 14 and into the tire having a lower air pressure. In this manner, air may be transferred from a tire of higher air pressure into a tire of lower air pressure by device 10. In this manner, air transfer device 10 may be used to regulate, equalize, substantially equalize and/or transfer air between tires, such as but not limited to those of a vehicle, and/or between tires of different vehicles.

Once air has inflated the lower pressure tire to a desired level (or if air has stopped transferring, such as in conditions where air pressure between the two tires connected to device 10 has equalized or substantially equalized), a user may disconnect attaching end 16 from the tire valve of the donor tire and locking end 12 from the tire valve of the receiving tire. Attaching end 16 and locking end 12 may be detached in any order. They may be attached in any order.

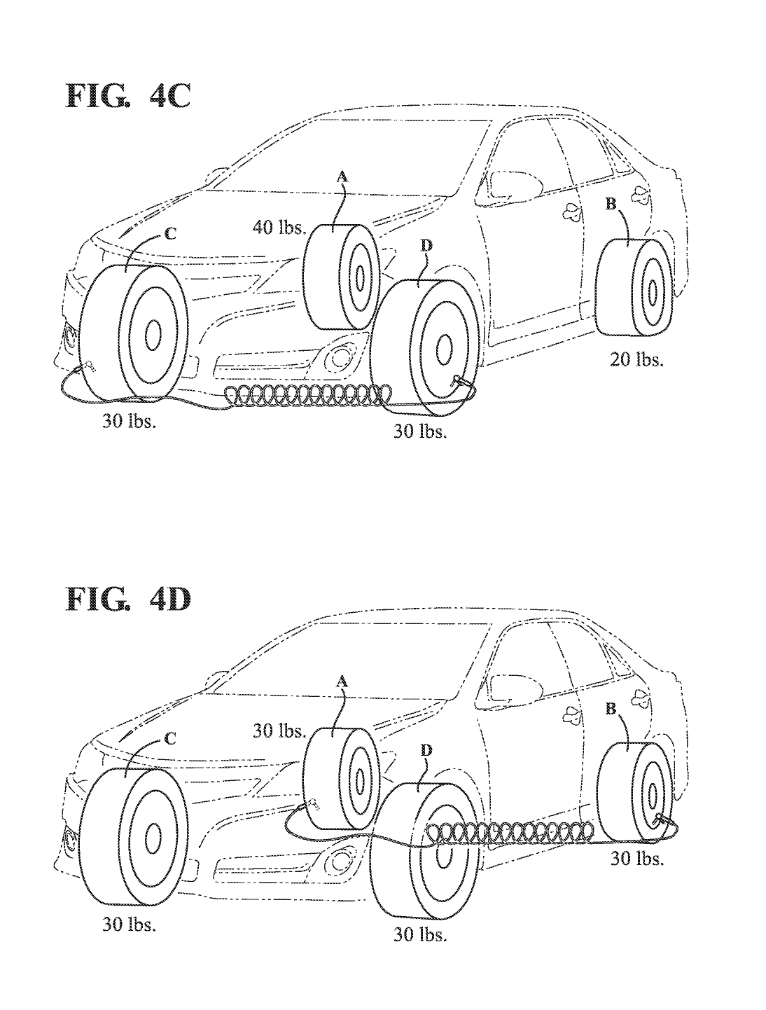

FIG. 4 shows one example of use of device 10. FIGS. 4a-4d show a flat tire example for an automobile having four wheels. In this example, wheels A, B, C and D are shown. As shown in FIG. 4a, wheels A, B and C each have 40# air pressure or inflation. Wheel D has gone flat and has 0# air pressure. A user may fix the hole, piercing, tear or other intrusion on the flat tire, such as but not limited to, by using a known product such as Spair™ and/or Fix-a-Flat® tire repair products. Once the aperture has been repaired, a user may use air transfer device 10 to add air to tire D. In this particular example, as shown in FIG. 4b, a user connects air transfer device 10 between tires B and D. Air is transferred therebetween, resulting in air pressure of 20# in each tire, tires B and D. Air pressure has thus been equalized between tires B and D. As shown in FIG. 4c, the user connects air transfer device 10 between tires C and D. Air is transferred therebetween, resulting in air pressure of 30# in each of tires C and D. Air pressure has thus been equalized between tires C and D. As shown in FIG. 4d, the user connects air transfer device 10 between tires A and B. Air is transferred therebetween, resulting in air pressure of 30# in each of tires A and B. Air pressure has thus been equalized between tires A and B. All four tires, A, B, C and D, now have 30# air pressure, and air pressure has thus been equalized between all four tires. Of course, many other uses are possible within the scope and spirit of this application, and claimed subject matter is not intended to be limited to this particular example or example.

In the example shown above, tires A, B, C, D may have air transferred therebetween in various different orders so as to achieve a result of equalized air pressure therebetween. For example, a user could connect air transfer device between tires C and D, A and D and/or B and D for an air transfer. Depending upon which tire is used as a donor tire, various combinations of tires connections may be used to achieve equalized air pressure. Tire A may be connected to tires B, C and/or D. Tire B may be connected to tires A, C and D. Tire C may be connected to tires A, B and D. Tire D may be connected to tires A, B and C, and so on, and the like. There exist numerous combinations of possible uses of air transfer device 10 so as to achieve equalized air pressure in this particular example. And many other examples are possible, using different types of vehicles, different numbers of tires, and the like. For example, air transfer device 10 may be used to transfer air to non-flat tires. Air transfer device 10 may be used to transfer air between tires of a towing vehicle and a trailer being towed. Many examples are possible, and claimed subject matter is not intended to be limited to this particular use.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of claimed subject matter is not limited in these respects. It should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the claims are intended to cover all such modifications and/or changes as fall within the true spirit of claimed subject matter.

1. A portable air hose device for transferring air between tires of one or more vehicles, comprising:
a locking end having a locking air valve for attaching to a tire valve of a tire into which air is to be transferred;
an attaching end having an air valve for attaching to a tire valve of a second tire from which air is to be transferred away; and
an air hose connected between the locking end and the attaching end with a substantially air tight connection, the air hose having an internal air pressure capable of transferring air between the tires if the locking end and attaching end are connected to the tires.

2. The portable air hose device of claim 1, the attaching end is locking and the air valve of the attaching end is a locking air valve.

3. The portable air hose device of claim 1, the attaching end is non-locking.

4. The portable air hose device of claim 1, the air hose is a coiling hose.

5. The portable air hose device of claim 1, the air hose is a straight hose.

6. The portable air hose device of claim 1, the air hose is a retractable hose.

7. The portable air hose device of claim 1, further comprising: a pressure gauge to measure air flow transfer.

8. The portable air hose device of claim 1, the device capable of transferring air from a tire of relatively higher air pressure to a tire of relatively lower air pressure.

9. The portable air hose device of claim 1, the device capable of transferring air from a tire of relatively higher air pressure to a flat tire.

10. A method for transferring air between tires of one or more vehicles, comprising;
attaching an air transfer device to a valve of a tire, the air transfer device having a locking end with a locking air valve for attaching to the valve of the tire, the air transfer device having an attaching end with an air valve for attaching to a valve of a second tire, and an air hose connected therebetween with a substantially air tight connection;
attaching the attaching end to the valve of the second tire having a relatively higher air pressure than the first tire; and
transferring air from the second tire to the first tire.

11. The method of claim 10, further comprising; transferring air from the second tire to the first tire until an air pressure of the first tire and an air pressure of the second tires are substantially equalized.

12. The method of claim 10, further comprising: transferring air from more than one of the tires of the vehicle to the first tire of relatively lower air pressure.

13. The method of claim 10, further comprising: transferring air from one or more tires of a second vehicle to the first tire of relatively lower air pressure.

14. The method of claim 10, further comprising: transferring air between the tires of the vehicle until the air pressure in all tires is substantially equalized.

15. The method of claim 10, the first tire of relatively lower air pressure comprises a flat tire.

16. The method of claim 10, further comprising measuring air flow transfer to the first tire with an air pressure gauge of the air transfer device.
